(19) United States
(12) Patent Application Publication
(10) Pub. No.: US 2021/0245784 A1
(43) Pub. Date: Aug. 12, 2021

(54) CONTROLLER FOR STEERING CONFIGURATIONS AND METHOD OF USING THE SAME

(71) Applicant: ZF Friedrichshafen AG, Friedrichshafen (DE)

(72) Inventors: Ananda Pandy, West Lafayette, IN (US); Pranav Salunke, West Lafayette, IN (US)

(21) Appl. No.: 16/814,213

(22) Filed: Mar. 10, 2020

Related U.S. Application Data
(60) Provisional application No. 62/971,417, filed on Feb. 7, 2020.

(51) Int. Cl. B60W 60/00; B60W 50/08; B60W 10/20; B60W 30/182

(52) U.S. Cl. CPC B60W 60/0054; B60W 50/085; B60W 2050/0095; B60W 30/182; B60W 2510/20; B60W 10/20

(57) ABSTRACT

A method of organizing and accessing vehicle steering preferences includes identifying first operating configurations from a first list and second operating configurations from a second list. The same file is assigned to each of the first and second operating configurations that are identical to one another. A unique file is assigned to each of the first and second operating configurations that is different from all the other first and second operating configurations. A request is received to operate the vehicle in a driving mode associated with one of the first operating configurations. The vehicle is automatically configured with the first operating configuration associated with the requested driving mode.

### RELATED APPLICATIONS

This application claims the benefit of U.S. Provisional Appln. Ser. No. 62/971,417, filed Feb. 7, 2020, the entirety of which is incorporated herein by reference.

### TECHNICAL FIELD

The present invention relates generally to steering systems, and specifically to a method of organizing and accessing vehicle steering configurations.

### BACKGROUND

Currently there are no steering system solutions for commercial vehicles available in the market to support higher levels of automation without a driver. Initial volume estimates do not support a dedicated project for custom development for each individual customer requesting an automated steering system. To this end, the general deviation in requests from different customers are in how the steering system behaves under different defined conditions.

### SUMMARY

In one example, a method of organizing and accessing vehicle steering preferences includes identifying first operating configurations from a first list and second operating configurations from a second list. The same file is assigned to each of the first and second operating configurations that are identical to one another. A unique file is assigned to each of the first and second operating configurations that is different from all the other first and second operating configurations. A request is received to operate the vehicle in a driving mode associated with one of the first operating configurations. The vehicle is automatically configured with the first operating configuration associated with the requested driving mode.

In another example, a controller for organizing and accessing vehicle steering preferences is configured to identify first operating configurations from a first list and second operating configurations from a second list. The same file is assigned to each of the first and second operating configurations that are identical to one another. A unique file is assigned to each of the first and second operating configurations that is different from all the other first and second operating configurations. A request is received to operate the vehicle in a driving mode associated with one of the first operating configurations. The vehicle is automatically configured with the first operating configuration associated with the requested driving mode.

Other objects and advantages and a fuller understanding of the invention will be had from the following detailed description and the accompanying drawings.

### BRIEF DESCRIPTION OF THE DRAWINGS

FIG. 1 is a schematic illustration of vehicle operation requirement lists.

FIG. 2 is a schematic illustration correlating different requirement lists to driving modes.

FIG. 3 is a flow chart of an example steering configuration method.

FIG. 4A is a schematic illustration of a vehicle including a controller.

FIG. 4B is a schematic illustration of a display in the vehicle of FIG. 4A.

### DETAILED DESCRIPTION

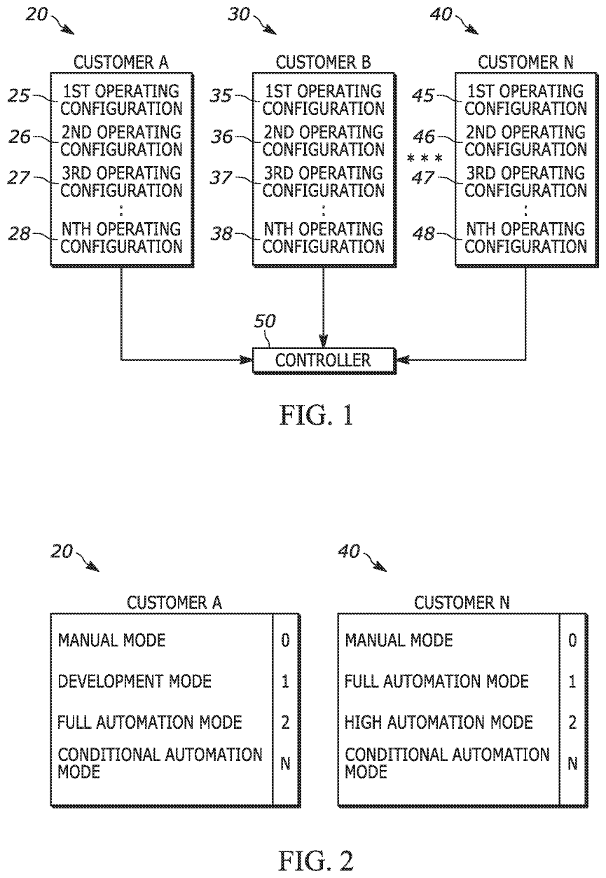

The present invention relates generally to steering systems, and specifically to a method of organizing and accessing vehicle steering configurations for commercial vehicles and/or non-commercial vehicles. FIG. 1 illustrates a series of customer requirement lists for steering-related vehicle configurations. Each list can be from a different source, e.g., vehicle supplier, vehicle manufacturer, customer, etc. Multiple lists can also come from the same source.

As shown, the lists originate from different customers. To this end, a first customer A has their own requirement list 20 of steering system operating configurations 25-28. A second customer B has their own requirement list 30 of steering system operating configurations 35-38. An n^{th} customer N has a requirement list 40 of steering system operating configurations 45-48. The steering system operating configurations are based on each customer demands, e.g., different levels of autonomous vehicle operation. It will be appreciated that when the lists originate from the same source the operating configurations can be based on different makes or models of vehicle or different demands for a particular vehicle.

In other words, the operating configurations 25-28, 35-38, 45-48 can correspond with different levels of autonomous driving the particular customers A, B, N want their vehicles to be equipped with/have access to. The lists 20, 30, 40 can include variations of the different levels or fall somewhere between levels.

The Society of Automotive Engineers (SAE) has 6 vehicle automation level definitions ranging from “0” (full-time performance by the human driver of all aspects of the dynamic driving task, even when enhanced by warning or intervention systems) to “5” (driving mode-specific performance by an automated driving system of all aspects of the dynamic driving task under all roadway and environmental conditions that can be managed by a human driver). In other words, level 0 is manual vehicle operation. Level 5 is fully autonomous driving.

In some instances, however, a customer may desire slight variations of these levels during initial developments. To this end, the customer may desire particular autonomous driving exit conditions for the operator and/or particular autonomous driving entry conditions. For example, a customer may want a mode in which the vehicle operates autonomously but a safety driver is positioned in the vehicle. The safety driver can rely on different methods of taking control of the vehicle, e.g., grabbing the steering wheel, brake pedal application, throttle position and/or changing the transmission gear.

The customer may also request specific internal faults that cause the vehicle to switch from fully [or partially] autonomous mode to manual mode, e.g., failed communication between the different steering units. The customer may also request particular operating configurations depending on the autonomous level selected, e.g., slew rate and/or steering response and feel.

Example customer-specific entry conditions for different autonomous driving levels can be based on vehicle speed, parking brake status, other vehicle faults, etc. That said, the requirement lists 20, 30, 40 can be the same as one another or different from one another. In any case, the requirement lists 20, 30, 40 are all related to the same vehicle function, e.g., vehicle steering systems. Other vehicle functions are contemplated.

According to the present invention, a single controller 50 includes an algorithm or software that organizes and synthesizes all the requirement lists 20, 30, 40 such that the same controller can be provided to all the customers A, B, N. In other words, the controller 50 is configured to operate in any of the customers' vehicles in a manner that enables the vehicle to meet the particular customer's desired operating configurations 25-28, 35-38, 45-48.

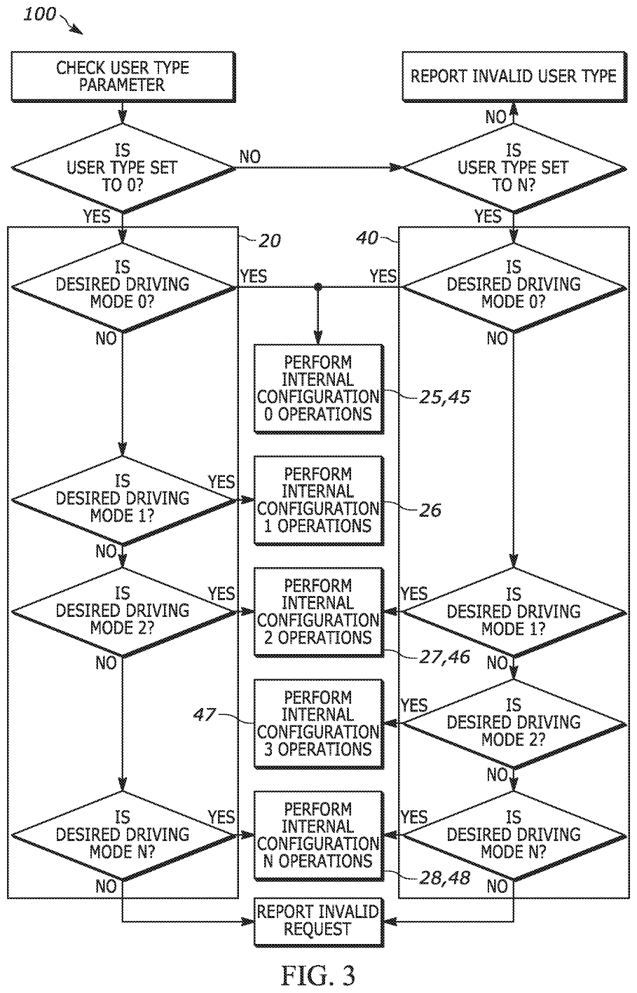

In one example, and referring to FIG. 2, the requirement list 20 for customer A includes operating configurations 25-28 that correspond, respectively, with a fully manual driving mode requirement (SAE level 0), a specialized mode requirement for development, a fully automated mode requirement (SAE level 5), and a conditional automation mode requirement (SAE level 3). The controller 50 assigns these modes for customer A to internal reference numbers 0, 1, 2, and n, respectively.

The requirement list 40 for customer N includes operating configurations 45-48 that correspond, respectively, with a fully manual driving mode requirement (SAE level 0), a fully automated mode requirement (SAE level 5), a highly automated mode requirement (SAE level 4), and a conditional automation mode requirement (SAE level 3). The controller 50 assigns these modes for customer N to internal reference numbers 0, 1, 2, and n, respectively.

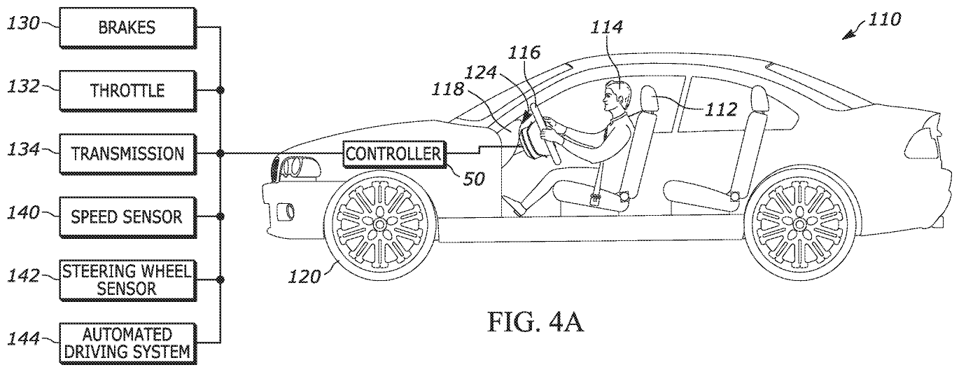

Referring to FIG. 3, a flow chart illustrates how the controller 50 accesses particular vehicle operating configurations once programmed with the requirement lists 20, 40 of customers A and N. The controller 50 is parameterized before delivery to each customer with a configuration meeting their respective requirements. Each customer A, N installs the same controller 50 in their respective vehicles.

Before delivering the controller 50 to a specific customer, the controller manufacturer enters a unique identification (indicated by “user type” at 100 in FIG. 3) for that customer into the controller. In this example, the controller 50 has assigned customer A with a “user type” of 0 and customer N with a “user type” of “n”. When multiple lists originate from the same source a unique identification can be given to each list, e.g., 0-1, 0-2, etc.

In any case, entering the user type automatically configures the controller 50 with the requirement list 20, 40 associated with that identification. As a result, the vehicle equipped with that controller 50 will operate under the customer-specific internal configurations for each autonomous driving mode provided in the respective requirement list 20 or 40.

When the controller 50 is then installed in the customer's vehicle, the controller compares the entered user type with the hard coded user type of the vehicle. In other words, the controller 50 compares the user type entered by the controller manufacturer to a user type pre-programmed into the vehicle. If the manufacturer attempts to configure the controller 50 with a user type identification that does not match the vehicle user type, an invalid user type is reported and the customer is denied further access to the controller 50. The controller 50 can compare the user types during every vehicle power up to ensure the controller is pre-programmed for and installed in the correct vehicle.

When a valid user type is entered, the occupant/operator of the vehicle or the automated driving system selects a desired driving mode, e.g., manual, driver assistance, full automation, etc., during vehicle operation. The controller 50 determines if the selected driving mode is part of the requirement list associated with the entered user type. If the answer is “yes’, the controller 50 automatically enables the vehicle with the particular operating configurations associated with that user type's driving mode. If the answer is “no”, the controller 50 reports an invalid driving mode request.

Each standard SAE autonomous driving mode or level has operating configurations associated therewith that are dictated by each particular customer. While many operating configurations are the same between customers in order to meet the particular SAE standard, some conditions can vary. Consequently, the unique operating configurations are separated from one another by the controller 50 whereas the common groups of operating configurations are linked together.

As shown in FIG. 3, it is clear that customers A and N share operating configurations 25, 45, operating configurations 27, 46, and operating configurations 28, 48, respectively. Customer A has unique operating configuration 26. Customer N has unique operating configuration 47. The software in the controller 50 advantageously combines identical operating configurations from different customers into a single file instead of repetitively creating different files for the same operating configuration. As a result, any additional customers that use the same operating configuration can be linked to the same file.

Moreover, any customer having a unique operating configuration can be given a new, distinct file. The controller of the present invention can therefore readily incorporate new customers into the existing infrastructure by both creating new files for new operating configurations and linking redundant operating configurations to existing files.

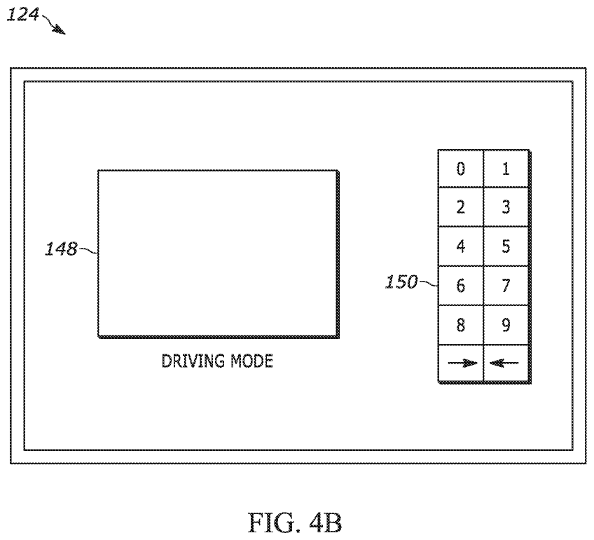

FIG. 4A shows the controller 50 of the present invention used in an example vehicle 110, e.g., a car (as shown) or truck (not shown) belonging to, for example, customer A. The vehicle 110 includes a seat 112 for receiving an occupant/operator 114. A steering wheel 116 is connected to an instrument panel 118 and is rotated to turn steerable wheels 120 on the vehicle 110. An interactive display 124 faces the occupant 114 and can be provided in the instrument panel 118. The display 124 is connected to the controller 50.

The controller 50 is connected to several vehicle components associated with autonomous driving and/or steering, namely, the vehicle brakes 130, throttle 132, and transmission 134. The controller 50 receives signals from these components 130, 132, 134 indicative of the status or condition thereof. A speed sensor 140 monitors the speed of the vehicle 110 and sends signals to the controller 50 indicative thereof. A steering wheel sensor 142 monitors the rotational position of the steering wheel 116 and sends signals to the controller 50 indicative thereof. An automated driving system 144 is connected to or integrally formed with the controller 50.

The customer A receives the pre-programmed controller 50 and installs it in the vehicle 110. Upon vehicle 110 startup, the controller 50 confirms the controller manufacturer entered the correct user type identification (in this case a user type of 0). The operator 114 can sit in the seat 112 and interact with the display 124 (see FIG. 4B) to automatically configure the vehicle 110 to any of the operating configurations pre-programmed into the controller 50.

To this end, the display 124 includes a driving mode entry box 148 and an interactive keypad 150 that cooperate to allow the operator to enter a desired driving mode, e.g., fully automated. If the desired driving mode matches one of the pre-programmed driving modes provided by the customer A the controller 50 automatically configures the steering system to the internal operating configurations 25-28 associated with the driving mode selection.

If, however, the desired driving mode does not match the driving modes provided by the customer A the display 124 notifies the operator 114 of an invalid driving mode selection. The operator 114 can notify the customer A of a desire for additional driving modes and/or operating configurations associated therewith. The customer A, in turn, can notify the controller 50 manufacturer such that the controller is updated to accommodate any changes by the customer.

It will be appreciated that when the vehicle is operated by an automated driving system 144, the automated driving system automatically/directly interacts with the controller 50 to request the desired driving mode (not shown). Consequently, in this example the entry box 148 and key pad 150 are not used.

That said, if the desired driving mode requested by the automated driving system 144 matches one of the pre-programmed driving modes provided by the customer A the controller 50 automatically configures the steering system to the internal operating configurations 25-28 associated with the driving mode selection. If, however, the desired driving mode requested by the automated driving system 144 does not match the driving modes provided by the customer A the controller 50 notifies the automated driving system of an invalid driving mode selection.

The same process is followed for any other customer wishing to enable particular operating configurations on their vehicles. In other words, the same controller 50 can be installed in different vehicles with the controller manufacturer pre-setting the controller to the customer-specific operating configurations. The unique user type identification and associated operating configurations allow any customer to tailor autonomous driving preferences to their vehicles using the same controller.

The present invention is advantageous in that it provides an optimized development method for steering systems. To this end, the steering system architecture is defined such that any variable used therein that can affect the behavior of the steering system is extracted as a tunable parameter. These tunable parameters can be grouped into internal configurations where the steering system behavior based on these tunable parameter conditions are defined.

The internal configuration options are then called for by a top-level parameter, such as the user type, which defines the expected steering system behavior for each of these tunable parameters. The internal configuration options can be used to put the steering system in a manual driving mode or automated driving with easy human takeover or automated driving with only automated driving system control.

This approach helps to do one standard optimized development and validation for all expected steering system behavior and requirements from different customers whereas the end deliverable with the defined top-level user type parameter ensures the customer specific steering system requirements are met.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method of organizing and accessing vehicle steering preferences, comprising:
identifying first operating configurations from a first list;
identifying second operating configurations from a second list;
assigning the same file to each of the first and second operating configurations that are identical to one another;
assigning a unique file to each of the first and second operating configurations that is different from all the other first and second operating configurations;
receiving a request to operate the vehicle in a driving mode associated with one of the first operating configurations; and
automatically configuring the vehicle with the first operating configuration associated with the requested driving mode.

2. The method of claim 1, wherein the first and second operating configurations comprise levels of driving automation.

3. The method of claim 2, wherein the first and second operating configurations each include a manual driving mode.

4. The method of claim 1, wherein the first operating configurations include a safety driver configuration in which the vehicle switches from autonomous to manual driving in response to the safety driver interacting with the vehicle.

5. The method of claim 4, wherein the safety driver interacts with the vehicle by grabbing the steering wheel.

6. The method of claim 4, wherein the safety driver interacts with the vehicle by changing a throttle of the vehicle.

7. The method of claim 1, wherein at least one of the first and second operating configurations includes autonomous driving entry conditions for the vehicle.

8. The method of claim 8, wherein the entry condition is dependent upon the vehicle speed.

9. The method of claim 8, wherein the entry condition is dependent a status of a parking brake of the vehicle.

10. The method of claim 1, wherein at least one of the first and second operating configurations includes steering feel dependent upon the autonomous driving level.

11. The method of claim 1, wherein the request is received from an occupant of the vehicle.

12. The method of claim 1, wherein the request is received from an automated driving system of the vehicle.

13. The method of claim 1, further comprising:
identifying third operating configurations from a third list;
assigning the same file to any of the third operating configurations that are identical to one of the first or second operating configurations; and
assigning a unique file to each of the third operating configurations that is different from all the first and second operating configurations.

14. A controller having an algorithm for performing the method recited in claim 1.

15. A controller for organizing and accessing vehicle steering preferences is configured to:
identify first operating configurations from a first list;
identify second operating configurations from a second list;
assign the same file to each of the first and second operating configurations that are identical to one another;
assign a unique file to each of the first and second operating configurations that is different from all the other first and second operating configurations;
receive a request to operate the vehicle in a driving mode associated with one of the first operating configurations; and
automatically configure the vehicle with the first operating configuration associated with the requested driving mode.

16. The controller of claim 15, wherein the first and second operating configurations comprise levels of driving automation.

17. The controller of claim 16, wherein the first and second operating configurations each include a manual driving mode.

18. The controller of claim 15, wherein the first operating configurations include a safety driver configuration in which the vehicle switches from autonomous to manual driving in response to the safety driver interacting with the vehicle.

19. The controller of claim 18, wherein the safety driver interacts with the vehicle by grabbing the steering wheel.

20. The controller of claim 18, wherein the safety driver interacts with the vehicle by changing a throttle of the vehicle.

21. The controller of claim 15, wherein at least one of the first and second operating configurations includes autonomous driving entry conditions for the vehicle.

22. The controller of claim 21, wherein the entry condition is dependent upon the vehicle speed.

23. The controller of claim 21, wherein the entry condition is dependent a status of a parking brake of the vehicle.

24. The controller of claim 15, wherein at least one of the first and second operating configurations includes steering feel dependent upon the autonomous driving level.

25. The controller of claim 15, being further configured to:
identify third operating configurations from a third list;
assign the same file to any of the third operating configurations that are identical to one of the first or second operating configurations; and
assign a unique file to each of the third operating configurations that is different from all the first and second operating configurations.

26. The controller of claim 15, wherein the request is received from an occupant of the vehicle.

27. The controller of claim 15, wherein the request is received from an automated driving system of the vehicle.
